(19) United States
(12) Patent Application Publication
(10) Pub. No.: US 2021/0241639 A1
(43) Pub. Date: Aug. 5, 2021

(54) LANDING ZONE SUITABILITY INDICATING SYSTEM

(71) Applicant: Lockheed Martin Corporation, Bethesda, MD (US)

(72) Inventors: Igor CHEREPINSKY, Sandy Hook, CT (US); George Nicholas LOUSSIDES, West Haven, CT (US); Margaret M. LAMPAZZI, Oxford, CT (US); Prateek SAHAY, Acton, MA (US); Mark D. Ward, Milford, CT (US)

(21) Appl. No.: 16/782,554

(22) Filed: Feb. 5, 2020

(51) Int. Cl. G08G 5/02; G08G 5/00; G02B 27/01

(52) U.S. Cl. CPC G08G 5/025; G01S 13/913; G02B 27/0172; G08G 5/0021

(57) ABSTRACT

A system and method of landing an aircraft. The system includes a human machine interface responsive to an input from an operator, and a processor. A region of interest for the aircraft is selected. A representation of a potential landing zone associated with the region of interest is presented at a human machine interface. A suitability of the potential landing zone for landing is evaluated to obtain an evaluation score. The evaluation score for the potential landing zone is presented at the human machine interface. An input is received at the human machine interface to select the potential landing zone. The aircraft is landed at the selected landing zone.

### BACKGROUND

The present invention relates to a system and method for operating an aircraft and, in particular, a system and method for evaluating a potential landing zone and selecting the potential landing zone for aircraft landing based on an evaluation score that conveys a quality and suitability of the chosen landing zone to an operator or pilot.

The suitability of a landing zone for a rotary-wing aircraft is currently visually assessed by the pilot prior to landing. The pilot looks outside of the aircraft to assess the landing zone and uses radar altimeter readings to determine a height above the landing zone, thereby flying the aircraft into the landing zone. The assessment of an unprepared landing zone by the pilot is a continuous visually intensive process that occurs while on approach to the landing zone and is highly dependent upon the pilot's ability to see the landing zone area and to evaluate the landing zone based on visual cues. Using visual inspection to land the aircraft relies on a pilot's skill and experience. A system is needed that can assess the quality and suitability of a potential landing zone and present this information to the operator for final decision or confirmation and to enhance operator trust in the autonomous system.

### BRIEF DESCRIPTION

According to an embodiment, a method of landing an aircraft. A region of interest for the aircraft is selected. A representation of a potential landing zone associated with the region of interest is presented at a human machine interface. A suitability of the potential landing zone for landing is evaluated to obtain an evaluation score. The evaluation score for the potential landing zone is presented at the human machine interface. An input is received at the human machine interface to select the potential landing zone. The aircraft is landed at the selected landing zone.

In addition to one or more of the features described above, presenting the evaluation score further includes presenting a graphical image representative of the evaluation score.

In addition to one or more of the features described above, the graphical image includes a graded scale and a score bar, a location of the score bar on the graded scale being indicative of a value the evaluation score.

In addition to one or more of the features described above, the graphical image includes an icon, further comprising receiving the input to select the potential landing zone at the icon.

In addition to one or more of the features described above, the method further includes displaying a minimum threshold bar at the graphical image.

In addition to one or more of the features described above, the method further includes receiving a selection input to select a potential landing zone for evaluation at the human machine interface, wherein the selection input is in response to an operator touching the representation of the potential landing zone at the human machine interface.

In addition to one or more of the features described above, the method further includes evaluating the potential landing zone based on at least one of: a flatness of the potential landing zone; a variation in the flatness of the potential landing zone; and a slope of the potential landing zone.

According to another embodiment, a system for landing an aircraft is disclosed. The system includes a human machine interface responsive to an input from an operator, and a processor. The processor is configured to: present a representation of a potential landing zone associated with a region of interest at the human machine interface, evaluate a suitability of the potential landing zone for landing to obtain an evaluation score, present the evaluation score for the potential landing zone at the human machine interface, receive an input at the human machine interface, the input selecting the potential landing zone, and land the aircraft in response to the input at the selected landing zone.

In addition to one or more of the features described above, the processor is further configured to present a graphical image representative of the evaluation score at the human machine interface.

In addition to one or more of the features described above, the graphical image includes a graded scale and a score bar, a location of the score bar on the graded scale being indicative of a value the evaluation score.

In addition to one or more of the features described above, the graphical image includes an icon, the processor further configured to receive the input to select the potential landing zone at the icon.

In addition to one or more of the features described above, the processor is further configured to display a minimum threshold bar for the evaluation score at the graphical image.

In addition to one or more of the features described above, the processor is further configured to select the potential landing zone for evaluation in response to a touch at the human machine interface of the representation of the potential landing zone.

In addition to one or more of the features described above, the evaluation score is based on at least one of a flatness of the potential landing zone; a variation in the flatness of the potential landing zone; and a slope of the potential landing zone.

The system of claim 8, wherein the human machine interface includes a a visor for a pilot.

### BRIEF DESCRIPTION OF THE DRAWINGS

The following descriptions should not be considered limiting in any way. With reference to the accompanying drawings, like elements are numbered alike:

FIG. 1 illustrates an exemplary vertical takeoff and landing (VTOL) rotary-wing aircraft having a dual, counter-rotating, coaxial rotor system;

FIG. 2 shows an interactive system for controlling operation of a landing procedure for the aircraft according to a pilot's review and consent;

FIG. 3 shows an illustrative image at the display screen of the human machine interface; and

FIG. 4 shows a flowchart illustrating a method for landing an aircraft as disclosed herein.

### DETAILED DESCRIPTION

A detailed description of one or more embodiments of the disclosed apparatus and method are presented herein by way of exemplification and not limitation with reference to the Figures.

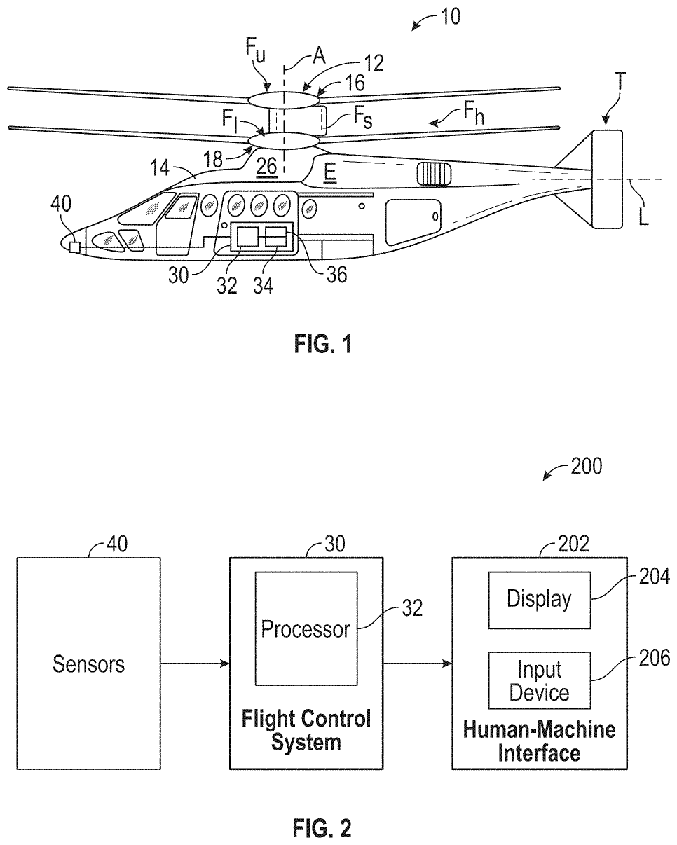

FIG. 1 illustrates an exemplary vertical takeoff and landing (VTOL) rotary-wing aircraft 10 having a dual, counter-rotating, coaxial rotor system 12 which rotates about an axis of rotation A. The rotary-wing aircraft 10 includes an airframe 14 which supports the dual, counter rotating, coaxial rotor system 12 as well as an optional translational thrust system T which provides translational thrust generally parallel to an aircraft longitudinal axis L. Although a particular aircraft configuration is illustrated in the disclosed embodiment, any type of aircraft systems will benefit from the present invention, including various other rotary aircraft. Additionally, the aircraft can be a fixed wing aircraft in various embodiments.

A main gearbox 26, which may be located above the aircraft cabin, drives the coaxial rotor system 12. The translational thrust system T may be driven by the same main gearbox 26 which drives the coaxial rotor system 12. The main gearbox 26 is driven by one or more engines (illustrated schematically at E). As shown, the main gearbox 26 may be interposed between the gas turbine engines E, the coaxial rotor system 12 and the translational thrust system T.

The rotary-wing aircraft 10 includes a flight control system 30 for autonomous control of the aircraft. The flight control system 30 includes a processor 32 and a storage medium 34 that includes various programs or instructions 36 stored therein. When accessed by the processor 32, the programs or instructions 36 enable the processor 32 to control various aspects of the aircraft includes control of flight surfaces, engine torque, gearbox, etc., in order to provide autonomous control of the rotary-wing aircraft 10. The flight control system 30 receives various input, such as Global Positioning Satellite (GPS) data, flight commands, flight plans, terrain data, environmental data for calculation of the control commands to be implemented at the aircraft.

The rotary-wing aircraft 10 further includes a one or more sensors 40 for measuring various parameter of the terrain and, in particular, to a potential landing zone. The one or more sensors 40 can include a Lidar system but can also include, for example, a radar system and a digital camera either in addition to the Lidar system or as alternatives. The parameter measurements obtained by the one or more sensors 40 can be used at the flight control system 30 to identify potential landing zones and to calculate an evaluation score that indicates the suitability of the potential landing zone for landing the aircraft 10, as discussed below.

FIG. 2 shows an interactive system 200 for controlling operation of a landing procedure for the aircraft according to a pilot's review and selection. The interactive system 200 includes the processor 32 of the flight control system 30 for performing various calculations disclosed herein, the one or more sensors 40 for obtaining measurements with respect to a selected terrain, and a human machine interface (HMI) 202 for presenting data to an operator and receiving input and/or selections from the operator.

The one or more sensors 40 can include, but is not limited to, the Lidar system. Upon approach of the aircraft to a selected region, or in response to a pilot's input, the one or more sensors 40 can be activated to obtain measurements regarding the selected region. In an embodiment, the one or more sensors 40 obtain Lidar data related to a selected terrain or a potential landing zone. The processor 32 uses the Lidar data to determine various parameters of the region such as a flatness of a potential landing zone, a variation of the flatness of the potential landing zone, a slope of the potential landing zone, etc. The processor 32 performs a calculation on the parameters of the regional terrain to identify a potential landing zone and to evaluate a suitability of the potential landing zone for landing the aircraft. In various embodiments, the suitability is a numerical evaluation score based on a selected combination of the values the parameters obtained by the Lidar system.

The suitable of the landing zone suitability can be based on factors or requirements specified by the operator. For example, if the mission is a search and rescue mission, the operator can enter additional risk factors or more complex factors for the processor to consider when determining landing zone suitability.

The human machine interface 202 can include a display 204 such as a touch screen for displaying images and for receiving input from the pilot or operator. Although pilot input can be received at the display 204, the human machine interface can further include other input devices 206, such as a keyboard, joystick, button, etc. in various alternative embodiments, the display 204 can be heads-up display or a visor that is placed over the eyes of the pilot. The processor 32 provides images of the region or terrain to the human machine interface 202 and receives various inputs and commands at the human machine interface 202.

In one embodiment, the processor 32 can send an aerial view of the region at the display 204. A color coding can be used in order to indicate various sub-regions within the aerial view. For example, a region of interest selected by the operator can be assigned a first color and the landing zones associated with the region can be assigned a second color. Any other coding system can be used at the human machine interface 202, in various embodiments. The processor 32 can further send a graphic image of an evaluation score for a potential landing zone at the display the human machine interface 202. A form or presentation of the graphic image can change based on which display is selected for viewing (e.g., touch screen vs. visor).

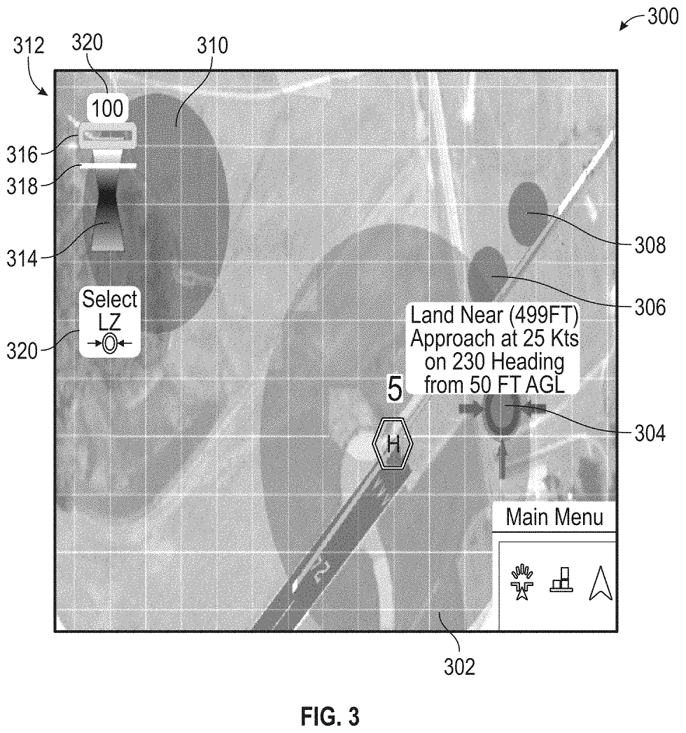

FIG. 3 shows an illustrative image 300 at the display screen of the human machine interface. An aerial view of a landscape is shown. A representation of a region of interest 302 selected by the pilot is indicated in a first color. Representations of potential landing zones 304, 306, 308, 310 are indicated using a second color, allowing the pilot to be able to see the potential landing zones selected by the system. In various embodiments, a first potential landing zone can be selected for consideration by the processor based on various parameters, such as its proximity to the selected region of interest 302. Otherwise, the pilot can select which potential landing zone to consider and evaluate

A graphical image 312 is shown to indicate the evaluation score for a potential landing zone 310 under consideration. The graphical image 312 is shown in proximity to the potential landing zone 310 being considered. The graphical image 312 includes a graded scale 314, with one end of the graded scale 314 indicating a minimum possible score and the other end indicating a maximum possible score. A score bar 316 is shown on the graded scale 314 to graphically indicate the numerical value of the evaluation score. The graphical image 312 can further show a minimum threshold bar 318 on the graded scale. The location of the minimum threshold bar 318 is indicative of a minimal allowable score for selecting the potential landing zone. The graphical image 312 can further include an icon 320 that the pilot can press at the touch screen in order to identify and select a different landing zone (other than the one the system selected). Assuming the pilot does not like the potential landing zone 310 under consideration or if the mission objective changes, the pilot can press the display at the location of another potential landing zone (e.g., either of potential landing zones 304, 306 or 308). When the pilot selects another potential landing zone for evaluation, the processor 32 performs calculations on the data related to the newly selected zone under consideration generates another graphical image proximate the newly selected zone under consideration.

The HMI 202 is not limited to use of a touchscreen button for selection of landing zone. In another embodiment, the HMI 202 can be a slew switch on a collective, cyclic stick or inceptor. In yet another embodiment, a new landing zone is represented by a symbol element in a helmet mounted display, and the pilot looks at new landing zone while pressing a button to select the new landing zone for evaluation.

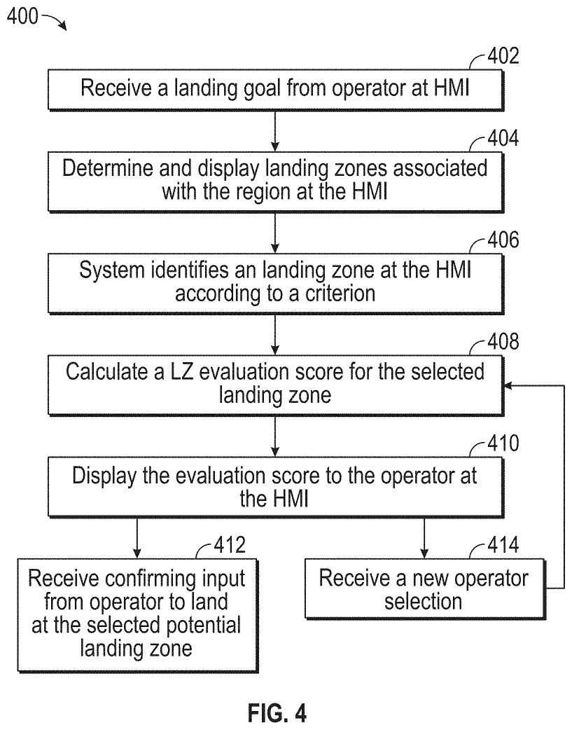

FIG. 4 shows a flowchart illustrating a method for landing an aircraft as disclosed herein. In box 402, an operator inputs a targeted landing area destination or a region of interest. This can be precise landing coordinates (such as latitude and longitude coordinates), or simply an area or region of interest to the operator. The region of interest can be any region that is related to a flight mission of the aircraft, such as a delivery or pickup location, rescue location, etc., or can be a region selected by the operator. The region of interest can be an area within a selected distance (e.g., 100 meters) of a destination. In box 404, the processor determines one or more potential landing zones in proximity to the region of interest or destination and displays the one or more potential landing zones at the HMI. The display can be in the form of a colored region on the screen. In box 406, the system can present an optimal landing zone selection and based on a selection criterion. The operator can intervene and change selected landing zone if desired. An evaluation score is determined for the landing zone selection. In various embodiments, the operator can touch the touch screen at the location of the colored region at the display. In box 408, the processor calculates an evaluation score for the selected potential landing zone. In box 410, the evaluation score is graphically displayed at the human machine interface. In box 412, the processor receives a confirming input from the operator to select the landing zone for landing. Either the operator or the processor can then land the aircraft at the selected landing zone. Alternatively, in box 414, the processor receives a selection input from the operator to select another potential landing zone for evaluation. From box 414, the method returns to box 408 in order to calculate the evaluation score for the newly selected potential landing zone.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of landing an aircraft, comprising:
selecting a region of interest for landing the aircraft;
presenting a representation of a potential landing zone associated with the region of interest at a human machine interface;
evaluating a suitability of the potential landing zone for landing to obtain an evaluation score; and
presenting the evaluation score for the potential landing zone at the human machine interface.

2. The method of claim 1, wherein presenting the evaluation score further comprises presenting a graphical image representative of the evaluation score.

3. The method of claim 2, wherein the graphical image includes a graded scale and a score bar, a location of the score bar on the graded scale being indicative of a value the evaluation score.

4. The method of claim 3, wherein the graphical image includes an icon, further comprising receiving an input to select the potential landing zone at the icon.

5. The method of claim 3, further comprising displaying a minimum threshold bar at the graphical image.

6. The method of claim 1, further comprising receiving a selection input to select a potential landing zone for evaluation at the human machine interface, wherein the selection input is in response to an operator touching the representation of the potential landing zone at the human machine interface.

7. The method of claim 1, further comprising evaluating the potential landing zone based on at least one of: a flatness of the potential landing zone; a variation in the flatness of the potential landing zone; and a slope of the potential landing zone.

8. A system for landing an aircraft, comprising:
a human machine interface; and
a processor configured to:
present a representation of a potential landing zone associated with a region of interest at the human machine interface;
evaluate a suitability of the potential landing zone for landing to obtain an evaluation score; and
present the evaluation score for the potential landing zone at the human machine interface.

9. The system of claim 8, wherein the processor is further configured to present a graphical image representative of the evaluation score at the human machine interface.

10. The system of claim 9, wherein the graphical image includes a graded scale and a score bar, a location of the score bar on the graded scale being indicative of a value the evaluation score.

11. The system of claim 10, wherein the human machine interface is responsive to an input from an operator and the graphical image includes an icon, the processor further configured to select the potential landing zone based on the input received via selection of the icon.

12. The system of claim 10, wherein the processor is further configured to display a minimum threshold bar for the evaluation score at the graphical image.

13. The system of claim 8, wherein the processor is further configured to select the potential landing zone for evaluation in response to a touch at the human machine interface of the representation of the potential landing zone.

14. The system of claim 8, wherein the evaluation score is based on at least one of a flatness of the potential landing zone; a variation in the flatness of the potential landing zone; and a slope of the potential landing zone.

15. The system of claim 8, wherein the human machine interface includes a a visor for a pilot.
